(19) United States
(12) Patent Application Publication
(10) Pub. No.: US 2024/0128536 A1
(43) Pub. Date: Apr. 18, 2024

(54) BATTERY TEMPERATURE ADJUSTMENT DEVICE

(71) Applicant: SUBARU CORPORATION, Tokyo (JP)

(72) Inventor: Toshiaki NARUKE, Tokyo (JP)

(73) Assignee: SUBARU CORPORATION, Tokyo (JP)

(21) Appl. No.: 18/377,004

(22) Filed: Oct. 5, 2023

(30) Foreign Application Priority Data
Oct. 14, 2022 (JP) 2022-165682

(51) Int. Cl. H01M 10/625; B60L 58/26; B60L 58/27; H01M 10/617

(52) U.S. Cl. CPC H01M 10/625; B60L 58/26; B60L 58/27; H01M 10/617

(57) ABSTRACT

A battery temperature adjustment device includes batteries and a controller. The batteries are configured to supply power to one or more motors of a vehicle and are different from each other in temperature characteristics. The controller is configured to adjust temperature of one or more batteries determined from the batteries depending on a predetermined condition.

### CROSS-REFERENCE TO RELATED APPLICATION

The present application claims priority from Japanese Patent Application No. 2022-165682 filed on Oct. 14, 2022, the entire contents of which are hereby incorporated by reference.

### BACKGROUND

The disclosure relates to a battery temperature adjustment device that adjusts the temperature of a battery installed in a vehicle.

A known battery temperature adjustment device proposed determines a battery the temperature adjustment for which is prioritized from multiple batteries, and adjusts the temperature of the determined battery, with a priority over the other batteries (see, for example, Japanese Unexamined Patent Application Publication (JP-A) No. 2020-4484).

### SUMMARY

An aspect of the disclosure provides a battery temperature adjustment device. The battery temperature adjustment device includes batteries and a controller. The batteries are configured to supply power to one or more motors of a vehicle and are different from each other in temperature characteristics. The controller is configured to adjust temperature of one or more batteries that are determined from the batteries depending on a predetermined condition.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a diagram illustrating a configuration of a vehicle.

FIG. 2 is a diagram illustrating a configuration of a battery temperature adjustment device.

FIG. 3 is a flowchart of temperature adjustment control processing.

FIG. 4 is a diagram illustrating a passage under a short distance mode.

FIG. 5 is a diagram illustrating a passage under a medium distance mode.

FIG. 6 is a diagram illustrating a passage under a normal state.

FIG. 7 is a diagram illustrating a passage during cooling.

### DETAILED DESCRIPTION

Some vehicles include batteries different from each other in temperature characteristics. There has been a demand for efficient temperature adjustment for the batteries in such a vehicle.

It is desirable to adjust the temperatures of the batteries efficiently.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

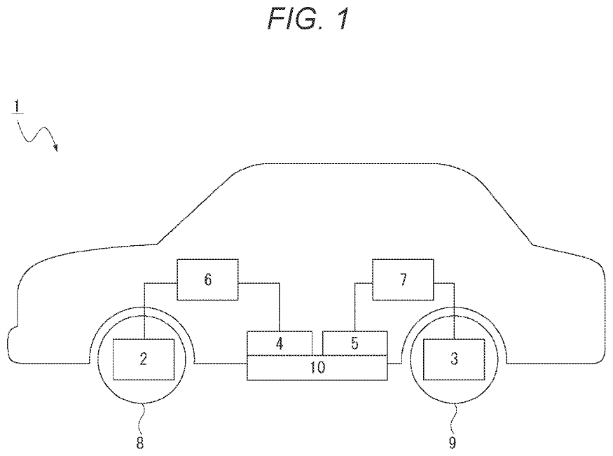

FIG. 1 is a diagram illustrating a configuration of a vehicle 1. As illustrated in FIG. 1, the vehicle 1 is an electric vehicle that includes a first motor 2, a second motor 3, a first secondary battery 4, a second secondary battery 5, a first inverter 6, a second inverter 7, front wheels 8, rear wheels 9, and a battery temperature adjustment device 10.

The first motor 2 and the second motor 3 are power sources for making the vehicle 1 travel, and are three-phase alternating current motors for example.

The first motor 2 generates driving force using power supplied from the first secondary battery 4 through the first inverter 6, and transmits the driving force to the front wheels 8.

The second motor 3 generates driving force using power supplied from the second secondary battery 5 through the second inverter 7, and transmits the driving force to the rear wheels 9.

The vehicle 1 travels with the front wheels 8 rotated by the driving force transmitted from the first motor 2, and with the rear wheels 9 rotated by the driving force transmitted from the second motor 3.

The first motor 2 and the second motor 3 can generate electricity (power) through a regenerative operation.

The electricity generated by the first motor 2 through the regenerative operation is supplied to the first secondary battery 4 through the first inverter 6. Thus, the first secondary battery 4 is charged.

The electricity generated by the second motor 3 through the regenerative operation is supplied to the second secondary battery 5 through the second inverter 7. Thus, the second secondary battery 5 is charged.

The first secondary battery 4 is a lithium ion secondary battery having an electrolyte disposed between the positive electrode and the negative electrode for example.

The second secondary battery 5 is an all-solid secondary battery in which a solid electrolyte layer is disposed between the positive electrode and the negative electrode for example.

The first secondary battery 4 and the second secondary battery 5 each include multiple cells.

The first secondary battery 4 and the second secondary battery 5 are different from each other in temperature characteristics. The “temperature characteristics” indicate physical properties such as the voltage, an internal resistance, and the like of a battery, relative to the temperature. Thus, the first secondary battery 4 and the second secondary battery 5 different from each other in temperature characteristics are also different from each other in an operation temperature range in which the battery can be favorably used with a low internal resistance. It has been known that the temperature characteristics vary among battery types of secondary batteries.

The operation temperature range of the first secondary battery 4 is, for example, a range such as −10° C. to 60° C., which is lower than that of the second secondary battery 5.

On the other hand, the operation temperature range of the second secondary battery 5 is, for example, a range such as 0° C. to 100° C., which is higher than that of the first secondary battery 4.

Thus, the first secondary battery 4 can be used at a lower temperature than the second secondary battery 5, and is unusable or is difficult to use at a higher temperature than the second secondary battery 5. In other words, the second secondary battery 5 is unusable or is difficult to use in a temperature range lower than that of the first secondary battery 4, and can be used in a temperature range higher than that of the first secondary battery 4.

The second secondary battery 5 can have a larger capacity and provide a larger output, than the first secondary battery 4. In view of this, the second motor 3 may be a motor featuring a larger output than the first motor 2.

The first inverter 6 converts the direct current supplied from the first secondary battery 4 into a three-phase alternating current, and supplies the alternating current to the first motor 2. When the first motor 2 performs the regenerative operation, the first inverter 6 converts the alternating current supplied from the first motor 2 into a direct current, and supplies the direct current to the first secondary battery 4.

The second inverter 7 converts the direct current supplied from the second secondary battery 5 into a three-phase alternating current, and supplies the alternating current to the second motor 3. When the second motor 3 performs the regenerative operation, the second inverter 7 converts the alternating current supplied from the second motor 3 into a direct current, and supplies the direct current to the second secondary battery 5.

The first secondary battery 4 and the second secondary battery 5 may be chargeable by power supplied from an external device not illustrated.

The battery temperature adjustment device 10 adjusts the temperatures of the first secondary battery 4 and the second secondary battery 5. The battery temperature adjustment device 10 will be described in detail below.

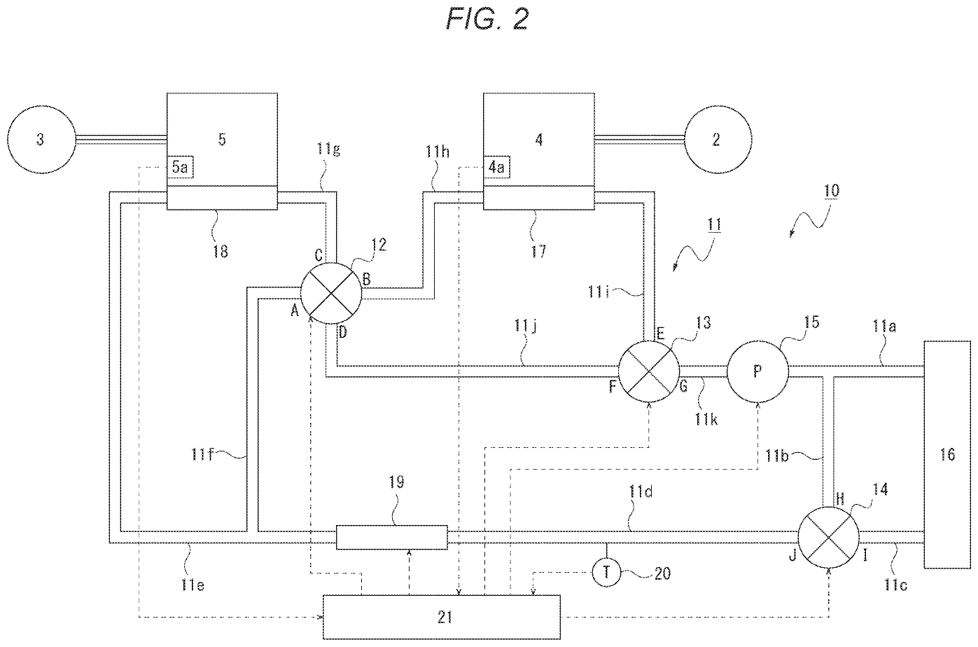

FIG. 2 is a diagram illustrating a configuration of the battery temperature adjustment device 10. In FIG. 2, dashed lines indicate signal flows.

As illustrated in FIG. 2, the battery temperature adjustment device 10 includes a heating medium passage 11, a four-way valve 12, a first three-way valve 13, a second three-way valve 14, a pump 15, a radiator 16, a first heat exchanger 17, a second heat exchanger 18, a heater 19, a heating medium thermometer 20, and a controller 21. The battery temperature adjustment device 10 also includes a thermometer 4a that measures the temperature of each cell in the first secondary battery 4, and a thermometer 5a that measures the temperature of each cell in the second secondary battery 5.

The heating medium passage 11 is a passage through which cooling water as a heating medium flows, and includes a heating medium passage 11a to a heating medium passage 11k. The heating medium passage 11a to the heating medium passage 11k will be described in detail below.

The four-way valve 12 is an electronically controlled valve that includes four ports being an A port, a B port, a C port, and a D port, and switches the ports in communication based on control by the controller 21. For example, the four-way valve 12 can have the A port and the B port in communication, and have the C port and the D port in communication. Furthermore, the four-way valve 12 can have the A port and the D port in communication, and have the B port and the C port in communication.

The first three-way valve 13 is an electronically controlled valve that includes three ports being an E port, an F port, and a G port, and switches the ports in communication based on control by the controller 21. For example, the first three-way valve 13 can have the E port and the G port in communication, and have the F port closed. Furthermore, the first three-way valve 13 can have the F port and the G port in communication, and have the E port closed.

The second three-way valve 14 is an electronically controlled valve that includes three ports being an H port, an I port, and a J port, and switches the ports in communication based on control by the controller 21. For example, the second three-way valve 14 can have the H port and the J port in communication, and have the I port closed. Furthermore, the second three-way valve 14 can have the I port and the J port in communication, and have the H port closed.

The pump 15 is an electric pump drivingly controlled by the controller 21. The pump 15 driven circulates the heating medium in the heating medium passage 11.

The radiator 16 is a heat exchanger that causes heat exchange between the heating medium flowing in the heating medium passage 11 and the outside air. The radiator 16 cools the heating medium, through transmission of heat to the outside air from the heating medium flowing in the heating medium passage 11.

The first heat exchanger 17 is disposed to be in contact with the first secondary battery 4, and causes heat exchange between the first secondary battery 4 and the heating medium flowing in the heating medium passage 11. Thus, the first heat exchanger 17 cools and heats the first secondary battery 4 using the heating medium flowing in the heating medium passage 11.

The second heat exchanger 18 is disposed to be in contact with the second secondary battery 5, and causes heat exchange between the second secondary battery 5 and the heating medium flowing in the heating medium passage 11. Thus, the second heat exchanger 18 cools and heats the second secondary battery 5 using the heating medium flowing in the heating medium passage 11.

The heater 19 is drivingly controlled by the controller 21. The heater 19 heats the heating medium flowing in the heating medium passage 11, using the power supplied from the first secondary battery 4.

The controller 21 includes a computer such as an Electronic Control Unit (ECU). The controller 21 acquires temperature measured by the thermometer 4a, the thermometer 5a, and the heating medium thermometer 20. The controller 21 performs comprehensive control on the battery temperature adjustment device 10, such as the control on the switching of the four-way valve 12, the first three-way valve 13, and the second three-way valve 14, the driving control on the pump 15, and the driving control on the heater 19.

In the battery temperature adjustment device 10, the heating medium passage 11a has one end coupled to the downstream side (discharge side) of the pump 15. The heating medium passage 11a has the other end coupled to the upstream end of the radiator 16. Thus, the heating medium passage 11a couples the pump 15 and the radiator 16 to each other.

The heating medium passage 11b has one end coupled to an intermediate part of the heating medium passage 11a. The heating medium passage 11b has the other end coupled to the H port of the second three-way valve 14. Thus, the heating medium passage 11b couples the pump 15 and the H port of the second three-way valve 14 to each other.

The heating medium passage 11c has one end coupled to the downstream end of the radiator 16. The heating medium passage 11c has the other end coupled to the I port of the second three-way valve 14. Thus, the heating medium passage 11c couples the radiator 16 and the I port of the second three-way valve 14 to each other.

The heating medium passage 11d has one end coupled to the J port of the second three-way valve 14. The heating medium passage 11d has the other end coupled to one end of the heating medium passage 11e and one end of the heating medium passage 11f. Thus, the downstream side of the heating medium passage 11d is branched into the heating medium passage 11e and the heating medium passage 11f.

The heating medium thermometer 20 and the heater 19 are provided in this order from the upstream side, at intermediate parts of the heating medium passage 11d. The heater 19 heats the heating medium flowing in the heating medium passage 11d. The heating medium thermometer 20 measures the temperature of the heating medium flowing in the heating medium passage 11d and before being heated by the heater 19.

The heating medium passage 11e has the other end coupled to the upstream end of the second heat exchanger 18. Thus, the heating medium passage 11e couples the J port of the second three-way valve 14 and the second heat exchanger 18 to each other through the heating medium passage 11d.

The heating medium passage 11f has the other end coupled to the A port of the four-way valve 12. Thus, the heating medium passage 11f couples the J port of the second three-way valve 14 and the A port of the four-way valve 12 to each other through the heating medium passage 11d.

The heating medium passage 11g has one end coupled to the downstream end of the second heat exchanger 18. The heating medium passage 11g has the other end coupled to the C port of the four-way valve 12. Thus, the heating medium passage 11g couples the second heat exchanger 18 and the C port of the four-way valve 12 to each other.

The heating medium passage 11h has one end coupled to the B port of the four-way valve 12. The heating medium passage 11h has the other end coupled to the upstream end of the first heat exchanger 17. Thus, the heating medium passage 11h couples the B port of the four-way valve 12 and the first heat exchanger 17 to each other.

The heating medium passage 11i has one end coupled to the downstream end of the first heat exchanger 17. The heating medium passage 11i has the other end coupled to the E port of the first three-way valve 13. Thus, the heating medium passage 11i couples the first heat exchanger 17 and the E port of the first three-way valve 13 to each other.

The heating medium passage 11j has one end coupled to the D port of the four-way valve 12. The heating medium passage 11j has the other end coupled to the F port of the first three-way valve 13. Thus, the heating medium passage 11j couples the D port of the four-way valve 12 and the F port of the first three-way valve 13 to each other.

The heating medium passage 11k has one end coupled to the G port of the first three-way valve 13. The heating medium passage 11k has the other end coupled to the upstream end (suction end) of the pump 15. Thus, the heating medium passage 11k couples the G port of the first three-way valve 13 and the pump 15 to each other.

In this manner, the battery temperature adjustment device 10 includes the passages in which the heating medium flows.

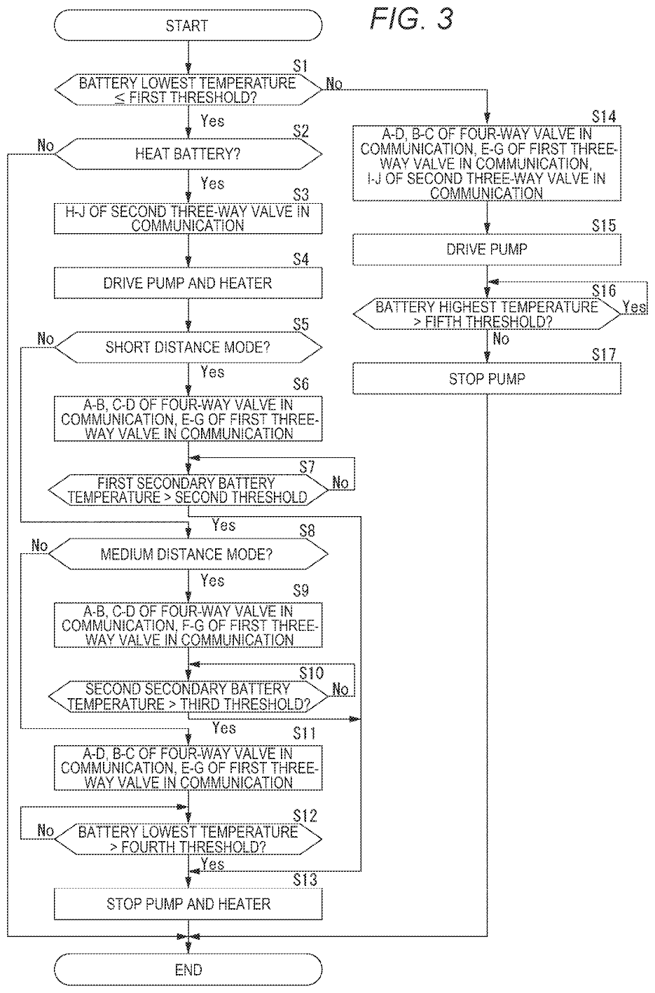

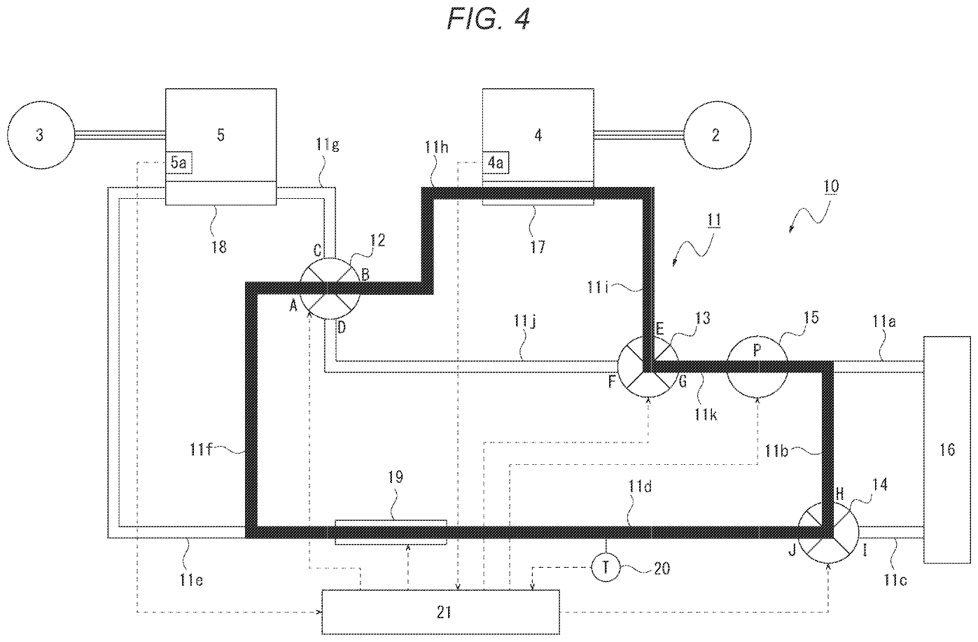

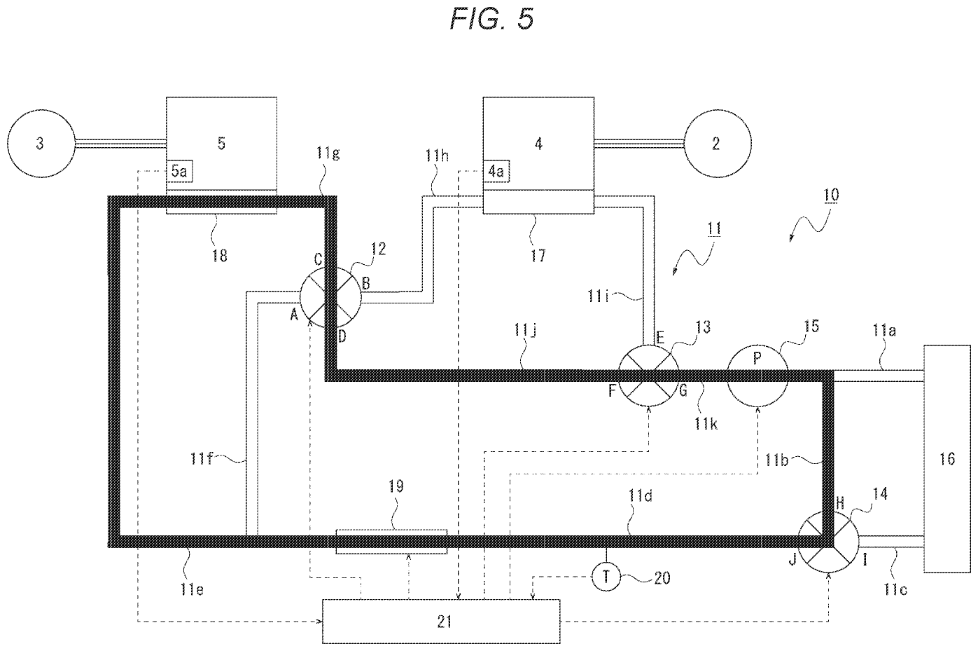

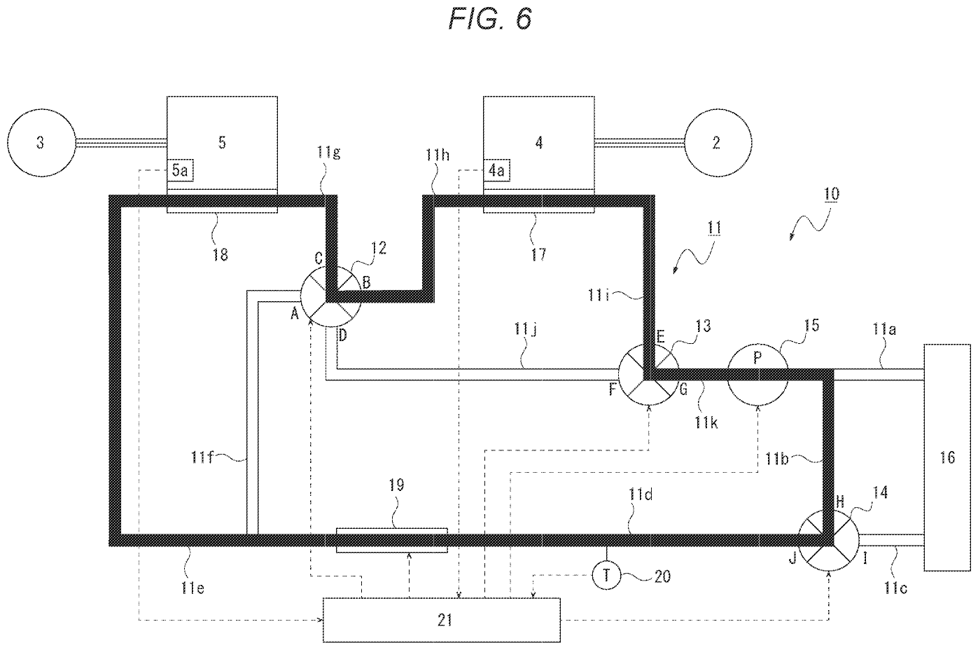

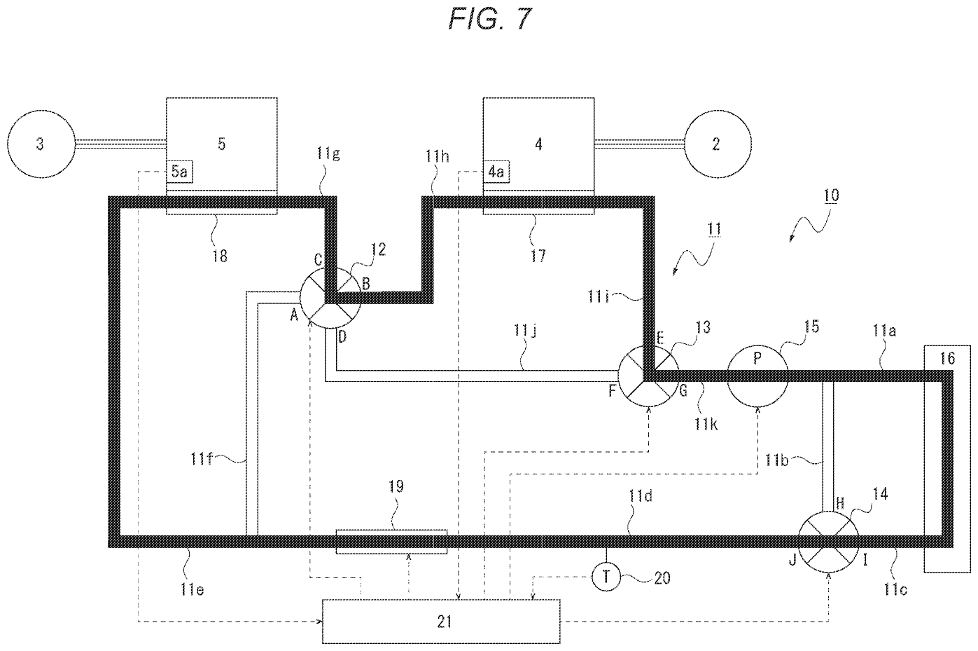

FIG. 3 is a flowchart of temperature adjustment control processing. FIG. 4 is a diagram illustrating a passage under a short distance mode. FIG. 5 is a diagram illustrating a passage under a medium distance mode. FIG. 6 is a diagram illustrating a passage under a normal state. FIG. 7 is a diagram illustrating a passage during cooling. The passages in which the heating medium flows are blacked out in FIG. 4 to FIG. 7.

Next, temperature adjustment control processing executed by the controller 21 will be described. As illustrated in FIG. 3, upon executing the temperature adjustment control processing, the controller 21 acquires the temperature of each cell of the first secondary battery 4 measured by the thermometer 4a, and acquires the temperature of each cell of the second secondary battery 5 measured by the thermometer 5a. The controller 21 determines whether a battery lowest temperature is equal to or below a first threshold (step S1). The battery lowest temperature is the lowest temperature among the temperatures of the cells of the first secondary battery 4 and the second secondary battery 5.

The first threshold is a temperature for switching between cooling and heating of the first secondary battery 4 and the second secondary battery 5, and is set to 10° C. for example.

When the battery lowest temperature is equal to or lower than the first threshold (Yes in step S1), that is, when there is a cell with a temperature equal to lower than the first threshold, the controller 21 determines that one or more of the first secondary battery 4 and the second secondary battery 5 is to be heated.

When the battery lowest temperature is higher than the first threshold (No in step S1), that is, when the temperatures of all the cells are higher than the first threshold, the controller 21 determines that one or more of the first secondary battery 4 and the second secondary battery 5 is to be cooled.

When the battery lowest temperature is equal to or lower than the first threshold (Yes in step S1), the controller 21 determines whether switching for performing heating on the first secondary battery 4 and the second secondary battery 5 is ON (step S2). As described above, the heater 19 performs the heating using the power from the first secondary battery 4. There can be a user who wants the power from the first secondary battery 4 to be consumed as little as possible. In the vehicle 1, whether the first secondary battery 4 and the second secondary battery 5 is to be heated can be switched through an operation by the user on a predetermined switch for example.

When the switch is OFF (No in step S2), the controller 21 ends the temperature adjustment control processing.

On the other hand, when the switch is ON (Yes in step S2), the controller 21 has the H port and the J port of the second three-way valve 14 in communication (step S3). As a result, the I port of the second three-way valve 14 is closed, and thus the heating medium does not flow into the radiator 16.

Then, the controller 21 drives the pump 15 and heats the heater 19 (step S4). As a result, the heating medium circulates through a predetermined passage in the heating medium passage 11, and the heating medium flowing in the heating medium passage 11 is heated by the heat from the heater 19.

In the embodiment, a short distance mode and a medium distance mode are provided as a travel mode.

The short distance mode is a mode under which the vehicle 1 only travels for a short distance (for example, shorter than 20 km). Under the short distance mode, the travel time is short and thus there is not much time for heating the battery. Thus, only the first secondary battery 4 with a low operation temperature range is heated.

The medium distance mode is a mode under which the vehicle 1 travels for a medium distance (for example, equal to or longer than 20 km and equal to or shorter than 100 km). Under the medium distance mode, the travel time is longer than that under the short distance mode, and thus there is a certain amount of time for heating the battery, meaning that the temperature rise of the battery by heat generation can be expected. Thus, only the second secondary battery 5 with a high operation temperature range is heated.

In the vehicle 1, the user operates a predetermined switch before the traveling starts, for example, to input a travel distance. The controller 21 determines the mode based on the travel distance input.

The controller 21 may calculate the travel distance based on the distance to the destination input to a car navigation device for example, and determine the mode based on the travel distance calculated.

The controller 21 may learn the use status of the vehicle 1, and determine the mode based on the result of the learning.

When the short distance mode is determined (Yes in step S5), the controller 21 has the A port and the B port of the four-way valve 12 in communication, and has the C port and the D port of the four-way valve 12 in communication. The controller 21 also has the E port and the G port of the first three-way valve 13 in communication (step S6).

As a result, as illustrated in FIG. 4, in the battery temperature adjustment device 10, the heating medium discharged from the pump 15 is guided to the location of the heater 19 through the heating medium passage lib, the second three-way valve 14, and the heating medium passage 11d. Then, the heating medium is heated by the heater 19. The heating medium heated is guided to the first heat exchanger 17 through the heating medium passage 11f, the four-way valve 12, and the heating medium passage 11h. The heating medium guided to the first heat exchanger 17 heats the first secondary battery 4. The heating medium after heating the first secondary battery 4 returns to the pump 15 through the heating medium passage 11i, the first three-way valve 13, and the heating medium passage 11k.

Thus, the heating medium does not flow into the radiator 16, and thus is not cooled, under the short distance mode. The heating medium flows in the first heat exchanger 17, but does not flow in the second heat exchanger 18. Thus, only the first secondary battery 4 is heated, and the second secondary battery 5 is not heated.

The vehicle 1 travels with the first motor 2 driven by the power supplied from the first secondary battery 4. During then, the second motor 3 is not driven (idling) in the vehicle 1 so as not to consume the power accumulated in the second secondary battery 5.

Then, the controller 21 acquires the temperature of each cell of the first secondary battery 4 measured by the thermometer 4a. The controller 21 determines whether the temperature of each cell of the first secondary battery 4 (first secondary battery temperature) is higher than a second threshold (step S7).

The second threshold is set to a temperature (for example, 0° C.) at which the first secondary battery 4 can be favorably used by being heated to be within the operation temperature range and is not to be heated thereafter.

Step S7 is repeated until the temperature of each cell of the first secondary battery 4 exceeds the second threshold. Once the temperature of each cell of the first secondary battery 4 exceeds the second threshold (Yes in step S7), the controller 21 advances the processing to step S13.

On the other hand, when the medium distance mode is selected (Yes in step S8), the controller 21 has the A port and the B port of the four-way valve 12 in communication, and has the C port and the D port of the four-way valve 12 in communication. The controller 21 also has the F port and the G port of the first three-way valve 13 in communication (step S9).

As a result, as illustrated in FIG. 5, in the battery temperature adjustment device 10, the heating medium discharged from the pump 15 is guided to the location of the heater 19 through the heating medium passage lib, the second three-way valve 14, and the heating medium passage 11d. Then, the heating medium is heated by the heater 19. The heating medium heated is guided to the second heat exchanger 18 through the heating medium passage 11e. The heating medium guided to the second heat exchanger 18 heats the second secondary battery 5. The heating medium after heating the second secondary battery 5 returns to the pump 15 through the heating medium passage 11g, the four-way valve 12, the heating medium passage 11j, the first three-way valve 13, and the heating medium passage 11k.

Thus, the heating medium does not flow into the radiator 16, and thus is not cooled, under the medium distance mode. The heating medium flows in the second heat exchanger 18, but does not flow in the first heat exchanger 17. Thus, only the second secondary battery 5 is heated, and the first secondary battery 4 is not heated.

The vehicle 1 travels with the second motor 3 driven by the power supplied from the second secondary battery 5. In this case, the vehicle 1 can travel with a larger output than the case where only the first motor 2 is driven. In the vehicle 1, the second secondary battery 5 can be less likely to fall out from the operation temperature range even when heated to a high temperature, since the operation temperature range of the second secondary battery 5 is higher than that of the first secondary battery 4. The first motor 2 is not driven (idling) in the vehicle 1 so as not to consume the power accumulated in the first secondary battery 4.

Then, the controller 21 acquires the temperature of each cell of the second secondary battery 5 measured by the thermometer 5a. The controller 21 determines whether the temperature of each cell of the second secondary battery 5 (second secondary battery temperature) is higher than a third threshold (step S10).

The third threshold is set to a temperature (for example, 10° C.) at which the second secondary battery 5 can be favorably used by being heated to be within the operation temperature range and is not to be heated thereafter.

Step S10 is repeated until the temperature of each cell of the second secondary battery 5 exceeds the third threshold. Once the temperature of each cell of the second secondary battery 5 exceeds the third threshold (Yes in step S10), the controller 21 advances the processing to step S13.

On the other hand, when the short distance mode is not determined (No in step S5), and the medium distance mode is not determined (No in step S8), that is, whether the travel distance is longer than that for the medium distance mode is unknown, the controller 21 advances the processing to step S11.

In step S11, the controller 21 has the A port and the D port of the four-way valve 12 in communication, and has the B port and the C port of the four-way valve 12 in communication. The controller 21 also has the E port and the G port of the first three-way valve 13 in communication (step S11).

As a result, as illustrated in FIG. 6, in the battery temperature adjustment device 10, the heating medium discharged from the pump 15 is guided to the location of the heater 19 through the heating medium passage lib, the second three-way valve 14, and the heating medium passage 11d. Then, the heating medium is heated by the heater 19. The heating medium heated is guided to the second heat exchanger 18 through the heating medium passage 11e. The heating medium guided to the second heat exchanger 18 heats the second secondary battery 5. The heating medium after heating the second secondary battery 5 is guided to the first heat exchanger 17 through the heating medium passage 11g, the four-way valve 12, and the heating medium passage 11h. The heating medium guided to the first heat exchanger 17 heats the first secondary battery 4. The heating medium after heating the first secondary battery 4 returns to the pump 15 through the heating medium passage 11i, the first three-way valve 13, and the heating medium passage 11k.

Thus, the heating medium does not flow into the radiator 16, and thus is not cooled, when whether the travel distance is longer than that for the medium distance mode is unknown. The heating medium flows in the first heat exchanger 17 and the second heat exchanger 18. Thus, the first secondary battery 4 and the second secondary battery 5 are both heated.

The vehicle 1 travels with the first motor 2 driven by the power supplied from the first secondary battery 4, and with the second motor 3 driven by the power supplied from the second secondary battery 5. Thus, the vehicle 1 can travel using the first motor 2 and the second motor 3.

Then, the controller 21 acquires the temperature of each cell of the first secondary battery 4 measured by the thermometer 4a, and acquires the temperature of each cell of the second secondary battery 5 measured by the thermometer 5a. Then, the controller 21 determines whether the battery lowest temperature is higher than a fourth threshold (step S12).

The fourth threshold is set to a temperature (for example, 10° C.) at which the first secondary battery 4 and the second secondary battery 5 are heated to be within the operation temperature range and are not to be heated thereafter.

Step S12 is repeated until the battery lowest temperature exceeds the fourth threshold. Once the battery lowest temperature exceeds the fourth threshold (Yes in step S12), the controller 21 advances the processing to step S13.

In step S13, the controller 21 stops the pump 15 and stops the heater 19 to stop heating the first secondary battery 4 and the second secondary battery 5.

When the battery lowest temperature is higher than the first threshold (No in step S1), the controller 21 has the A port and the D port of the four-way valve 12 in communication, and has the B port and the C port of the four-way valve 12 in communication. The controller 21 also has the E port and the G port of the first three-way valve 13 in communication. Furthermore, the controller 21 has the I port and the J port of the second three-way valve 14 in communication (step S14).

The controller 21 drives the pump 15 (step S15). The controller 21 keeps the heater 19 stopped.

As a result, as illustrated in FIG. 7, in the battery temperature adjustment device 10, the heating medium discharged from the pump 15 is guided to the radiator 16 through the heating medium passage 11a. The heating medium guided to the radiator 16 is cooled by the radiator 16.

The heating medium cooled is guided to the location of the heater 19 through the heating medium passage 11c, the second three-way valve 14, and the heating medium passage 11d. Still, the heating medium is not heated because the heater 19 is stopped.

The heating medium after passing through the heater 19 is guided to the second heat exchanger 18 through the heating medium passage 11e. The heating medium guided to the second heat exchanger 18 cools the second secondary battery 5. The heating medium after cooling the second secondary battery 5 is guided to the first heat exchanger 17 through the heating medium passage 11g, the four-way valve 12, and the heating medium passage 11h. The heating medium guided to the first heat exchanger 17 cools the first secondary battery 4. The heating medium after cooling the first secondary battery 4 returns to the pump 15 through the heating medium passage iii, the first three-way valve 13, and the heating medium passage 11k.

As described above, the heating medium flows in the radiator 16 to be cooled, at the time of cooling. The heating medium flows in the first heat exchanger 17 and the second heat exchanger 18. Thus, the first secondary battery 4 and the second secondary battery 5 are both cooled.

The vehicle 1 travels with the first motor 2 driven by the power supplied from the first secondary battery 4, and with the second motor 3 driven by the power supplied from the second secondary battery 5. Thus, the vehicle 1 can travel using the first motor 2 and the second motor 3.

Then, the controller 21 acquires the temperature of each cell of the first secondary battery 4 measured by the thermometer 4a, and acquires the temperature of each cell of the second secondary battery 5 measured by the thermometer 5a. The controller 21 determines whether a battery highest temperature is higher than a fifth threshold (step S16). The battery highest temperature is the highest temperature among the temperatures of the cells of the first secondary battery 4 and the second secondary battery 5.

The fifth threshold is set to a temperature (for example, 40° C.) at which the first secondary battery 4 and the second secondary battery 5 are cooled to be within the operation temperature range and are not to be cooled thereafter.

Step S16 is repeated until the battery highest temperature drops to or below the fifth threshold. Once the battery highest temperature drops to or below the fifth threshold (No in step S16), the controller 21 stops the pump 15 (step S17), and ends the temperature adjustment control processing.

The above embodiment is an example of the disclosure, and the embodiment of the disclosure is not limited to the above example, and various modified examples are contemplated.

For example, in the above embodiment, the temperature is adjusted on one or both of the first secondary battery 4 and the second secondary battery 5 determined depending on the travel mode. Alternatively, the controller 21 may adjust the temperature of one or both of the first secondary battery 4 and the second secondary battery 5, depending on a predetermined condition including the travel mode.

In the above embodiment, the heating medium flows in the heating medium passage 11 illustrated in FIG. 2. However, the passage for the heating medium is merely an example, and the passage may have other configurations.

In the above embodiment, a lithium ion secondary battery and an all-solid secondary battery are described as examples of the first secondary battery 4 and the second secondary battery 5 different from each other in temperature characteristics. However, any combination between the secondary batteries and any number thereof may be employed as long as the batteries different from each other in temperature characteristics are provided in the vehicle 1.

In the above embodiment, the first motor 2 is driven by the power from the first secondary battery 4, and the second motor 3 is driven by the power from the second secondary battery 5. Alternatively, only a single motor may be provided in the vehicle 1, and the motor may be driven by the power from the first secondary battery 4 and the second secondary battery 5.

In the above embodiment, the heating ends when the temperature of each cell in the second secondary battery 5 is higher than the third threshold under the medium distance mode (Yes in step S10). Alternatively, the controller 21 advances the processing to step S11 to heat the first secondary battery 4 and the second secondary battery 5, when the temperature of each cell of the second secondary battery 5 is higher than the third threshold (Yes in step S10). With this configuration, the first secondary battery 4 can be heated to be in the operation temperature range by the heat discharged from the second secondary battery 5.

In the above embodiment, the heater 19 is driven for heating the first secondary battery 4 and the second secondary battery 5. Alternatively, the controller 21 may stop the heater 19 as appropriate, based on the temperature of the heating medium measured by the heating medium thermometer 20.

As described above, the battery temperature adjustment device 10 of the embodiment includes multiple batteries (the first secondary battery 4 and the second secondary battery 5) that are configured to supply power to motors (the first motor 2 and the second motor 3) of the vehicle 1 and are different from each other in temperature characteristics, and the controller 21 configured to adjust temperature of a battery determined from the batteries depending on a predetermined condition.

With this configuration, the battery temperature adjustment device 10 can adjust the temperature of a battery that can be easily set to have a temperature within the operation temperature range, and a battery that can be easily maintained in the operation temperature range depending on the predetermined condition. In this case, the battery temperature adjustment device 10 adjusts the temperature of one battery only, and thus can swiftly make the battery have a temperature within the operation temperature range. Thus, the battery temperature adjustment device 10 can efficiently adjust the temperature of the battery.

The battery temperature adjustment device 10 can reduce the deterioration of the battery due to the use outside the operation temperature range.

The controller 21 adjusts the temperature of the battery (the first secondary battery 4, the second secondary battery 5) determined depending on the travel mode of the vehicle 1.

Thus, the battery temperature adjustment device 10 can adjust the temperature of the optimum battery depending on the travel mode.

The travel mode includes the short distance mode for traveling a distance that is shorter than the first distance, and the medium distance mode for traveling a distance that is equal to or longer than the first distance and equal to or shorter than the second distance.

Thus, the battery temperature adjustment device 10 can adjust the temperature of the optimum battery, depending on the short distance mode for a short travel distance and the medium distance mode for a relatively long travel distance.

For example, under the short distance mode, the travel time is short and thus there is not so much time for heating the battery. Thus, the temperature is adjusted only on the first secondary battery 4 with a low operation temperature range. Under the medium distance mode, the travel time is longer, and thus there is a certain amount of time for heating the battery, meaning that the temperature rise of the battery by heat generation can be expected. Thus, the temperature is adjusted only on the second secondary battery 5 with a high operation temperature range.

With the temperature thus adjusted on the optimum battery depending on the travel mode, the temperature of the battery can be in the operation temperature range swiftly and for a long period of time.

The controller 21 adjusts the temperature of a battery with a low operation temperature range under the short distance mode, and adjusts the temperature of a battery with a high operation temperature range under the medium distance mode.

Thus, under the short distance mode, the temperature can be efficiently adjusted on the first secondary battery 4 with a low operation temperature range. Under the medium distance mode, the temperature can be efficiently adjusted on the second secondary battery 5 with a high operation temperature range.

The batteries supply power to different ones of the motors.

Thus, the motor receiving power from the battery under the temperature adjustment can be driven. With the motor used in this case in accordance with the capacity and the output of the battery, the vehicle 1 can efficiently travel.

The controller 21 illustrated in FIG. 2 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the controller 21 illustrated in FIG. 2. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the controller 21 illustrated in FIG. 2.

1. A battery temperature adjustment device comprising:
batteries configured to supply power to one or more motors of a vehicle and are different from each other in temperature characteristics; and
a controller configured to adjust temperature of one or more of the batteries determined from the batteries depending on a predetermined condition.

2. The battery temperature adjustment device according to claim 1, wherein the controller is configured to adjust temperature of the one or more batteries that are determined depending on a travel mode of the vehicle.

3. The battery temperature adjustment device according to claim 2, wherein the travel mode includes a short distance mode for traveling a distance that is shorter than a first distance, and a medium distance mode for traveling a distance that is equal to or longer than the first distance and equal to or shorter than a second distance.

4. The battery temperature adjustment device according to claim 3, wherein the controller is configured to adjust temperature of the one or more batteries that have a low operation temperature range under the short distance mode, and adjust temperature of the one or more batteries that have a high operation temperature range under the medium distance mode.

5. The battery temperature adjustment device according to claim 1, wherein
the one or more motors comprises a first motor and a second motor different from the first motor,
the batteries comprise a first battery and a second battery different from the first battery, and
the first battery supply power to the first motor, and the second battery supply power to the second motor.

6. The battery temperature adjustment device according to claim 2, wherein
the one or more motors comprises a first motor and a second motor different from the first motor,
the batteries comprises a first battery and a second battery different from the first battery, and
the first battery supply power to the first motor, and the second battery supply power to the second motor.
